(19) United States
(12) Patent Application Publication
(10) Pub. No.: US 2007/0205986 A1
(43) Pub. Date: Sep. 6, 2007

(54) Metal Keypad Assembly for Mobile Phone and Manufacturing Method of Keypad

(76) Inventors: Hak Won Kim, Incheon (KR); Ji Woong Bae, Incheon (KR)

Correspondence Address: FROMMER LAWRENCE & HAUG, 745 FIFTH AVENUE- 10TH FL., NEW YORK, NY, 10151, US

(21) Appl. No.: 10/592,894

(22) PCT Filed: Mar. 15, 2005
(86) PCT No.: PCT/KR05/00750

§ 371 Date: Mar. 21, 2007

(30) Foreign Application Priority Data
Mar. 17, 2004 (KR) 10-2004-0017865
Apr. 19, 2004 (KR) 10-2004-0026808
Oct. 27, 2004 (KR) 10-2004-0086384

(51) Int. Cl. G06F 3/02

(52) U.S. Cl. 345/168; 341/22

(57) ABSTRACT

There is provided a keypad assembly operating a dome switch of a mobile phone. The keypad assembly includes a keypad disposed on the dome switch and having a plurality of bosses protruded from a position corresponding to the movable contacts, and a plurality of metal keys each disposed on the keypad at a position corresponding to each boss and protruding from a surface of the housing at a desired height, each of the metal keys formed with a numeral and/or character display penetrating through an upper surface thereof. Since the metal key is made of metal, it represents a metal feeling, in addition to various colors. Also, since the metal key is slimmed, it minimizes a thickness of the mobile phone. In addition, a process for forming the keypad is minimized thereby to reduce additional cost.

### TECHNICAL FIELD

The present invention relates to a keypad assembly used to operate a dome switch of a mobile phone, and more particularly, to a keypad assembly with a keypad made of metal, which can diversify a color of the keypad and slim a thickness of the keypad, as well as easily forming the keypad, and a method of manufacturing the same.

### BACKGROUND ART

A mobile phone is a wireless communication appliance capable of allowing a user to carry and use it with her or him. Such a mobile phone is manufactured to have various types of phones comprising a bar-type phone with exposed key buttons, a flip-type phone with a flip cover to facilitate portability and use of the phone, a folder-type compact phone developed to further improving the portability, and the like.

In addition, the mobile phone includes a keypad assembly as inputting means of carrying out several functions of wireless communication. The keypad assembly has a keypad made of a flexible synthetic resin, such as silicon or rubber, and represented by characters and/or symbols which are touched by the user.

Referring to FIG. 1, a conventional keypad assembly includes a plurality of movable contacts (also referred to as “metal dome”) 102 disposed on a printed circuit board 101 for operating buttons, a base 110 disposed on the movable contacts 102 and having a contact boss for operating each movable contact 102, and a keypad 120 held by the base 110 and fixed to a button housing 103 of a phone on the base 110.

The flexible property of the keypad 120 causes the keypad to be mechanically unstable. Also, a printed surface on which numerals and/or characters are directly printed is likely deformed or erased. Specifically, the numeral and/or characters printed on the surface of the keypad are peeled off from the surface by repeatedly bending the keypad for a long time, as well as decreasing discrimination thereof due to dis-coloration and scratch.

It is impossible to achieve various colors and patterns form the keypad 120, which does not provide the keypad with an esthetic sense. In addition, the keypad is formed to have a thickness enough to withstand the repeated bending. Consequently, since the keypad becomes thick, it is difficult to slim the mobile phone.

Also, the keypad 120 should be formed by a support tool separately manufactured according to an initial design, which increases a cost for preparing a mold. In addition, since the keypad is assembled with several components, it takes long to assemble the keypad, thereby increasing a manufacturing cost thereof. Hence, a cost of a product is relatively increased.

### DISCLOSURE OF INVENTION

Technical Problem

Therefore, an object of the present invention is to solve the problems involved in the prior art, and to provide a keypad assembly with a keypad made of metal, which can diversify a color of the keypad and slim a thickness of the keypad, as well as easily forming the keypad, and a method of manufacturing the same.

Technical Solution

According to one aspect of the present invention, there is provided a keypad assembly for a mobile phone including a housing for holding a printed circuit board having a plurality of stationary contacts, and a dome switch having a plurality of movable contacts and disposed on the printed circuit board 60, the keypad assembly comprising: a keypad disposed on the dome switch and having a plurality of bosses protruded from a position corresponding to the movable contacts; a plurality of metal keys each disposed on the keypad at a position corresponding to each boss and protruding from a surface of the housing at a desired height, each of the metal keys formed with a numeral and/or character display penetrating through an upper surface thereof; and a synthetic resin filled in the numeral and/or character display of the metal key to transmit light through the numeral and/or character display.

According to another aspect of the present invention, there is provided a keypad assembly for a mobile phone comprising: a contact base made of synthetic resin covering movable contacts and having a plurality of contact bosses protruding downward from the contact base at a position corresponding to the movable contacts to operate button portion; a metal key having a keypad covering an upper surface of the contact base and formed with punched portions for numerals and/or characters corresponding to the contact bosses, and a housing enclosing the keypad; and a molding portion each filled in the punched portions of the metal key coupled to an upper portion of the contact base.

According to further another aspect of the present invention, there is provided a method of manufacturing a keypad assembly for a mobile phone including a housing for holding a printed circuit board having a plurality of stationary contacts, and a dome switch having a plurality of movable contacts and disposed on the printed circuit board, the method comprising the steps of: making a design of a keypad; primarily machining a metal plate to form a metal keypad having the same design as that of the keypad and integrally formed with a plurality of metal keys; processing a plurality of metal keys through screen print, metal mask, dosing discharge of discharger, and spray, and fixing a base film having no contractile deformation; and secondarily machining only connecting portion between the metal keys.

Advantageous Effects

Since a plurality of metal keys each disposed on the keypad at a position corresponding to each boss, the metal keys are not discolored or deformed by repeated use, and numerals and/or characters are not erased.

Also, each of the metal keys is formed with a numeral and/or character display penetrating through an upper surface thereof, and the numeral and/or character display is filled with synthetic resin having good light transmittance, so that it is possible to prevent alien substance from being held between the numerals and/or character display and to transmit backlighting through the metal key.

In addition, since a front surface of the metal key is exposed from a housing in the keypad assembly, an image of the mobile phone may be represented as a metal feeling to improve the purchase of the mobile phone of interest.

Also, since the metal keys operating button portion are formed with metal in the keypad assembly, it is possible to make the keypad in various colors. Also, the keypad may represent the natural metal feeling due to a unique color thereof.

Furthermore, the keypad can be made in various shapes, and a thickness of the keypad can be slimed, thereby minimizing a thickness of the mobile phone.

Also, since the keypad is machined by etching, it can remarkably reduce a manufacturing cost as compared with a conventional keypad assembly using a mold. In addition, the keypad is integrally formed with the housing to assemble the metal keys and button portion at once, thereby further reducing the manufacturing cost.

Furthermore, the metal keys may be formed with only keypad to provide another esthetic sense. Of course, an upper surface of the metal key may be coated with a surface protecting film to form the metal key in various shapes and thus advance the image of the mobile phone.

In addition, since the metal keys are maintained from a primary machining process to an assembling process, it can solve a quality problem, such as misalignment, separation or the like, caused by a conventional process in which keys are separately inserted into a jig tool and assembled.

Also, the metal keys may have various patterns such as hair line, and various shapes. The metal keys have good discoloration resistance and durability, since initial color and design of metal are maintained for a long time.

Finally, the thickness of the metal key can be reduced to ⅓or less compared with a conventional key manufacturing method. Also, since the metal key is made by the laser beam or etching, a specific tool is not required. As such, the metal key can be mass produced, and adaptation for design change is excellent.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a cross-sectional view of a conventional keypad assembly.

FIG. 2 is a top view of a keypad assembly according to a first embodiment of the present invention.

FIG. 3 is an exploded view of the keypad assembly in FIG. 2.

FIG. 4 is a cross-sectional view taken along a line IV-IV in FIG. 2.

FIG. 5 is a view illustrating a keypad assembly according to a second embodiment of the present invention.

FIG. 6 is a cross-sectional view of the keypad assembly in FIG. 5.

FIG. 7 is an exploded view of the keypad assembly in FIG. 5.

FIG. 8 is a cross-sectional view of a keypad assembly according to an alternative embodiment of the present invention.

FIG. 9 is a view of a keypad assembly according to another alternative embodiment of the present invention.

FIG. 10 is a cross-sectional view illustrating a coating of a keypad assembly according to the present invention.

FIG. 11 is a top view illustrating a keypad assembly according to a third embodiment of the present invention.

FIG. 12 is a flowchart showing a manufacturing process of a keypad assembly according to the present invention.

FIG. 13 is a view illustrating a first process of manufacturing the keypad assembly in FIG. 12.

FIG. 14 is a view illustrating a second process of manufacturing the keypad assembly in FIG. 12.

FIG. 15 is a view illustrating a third process of manufacturing the keypad assembly in FIG. 12.

FIG. 16 is a view illustrating a fourth process of manufacturing the keypad assembly in FIG. 12.

FIG. 17 is a cross-sectional view illustrating an assembled state of the keypad assembly in FIG. 12.

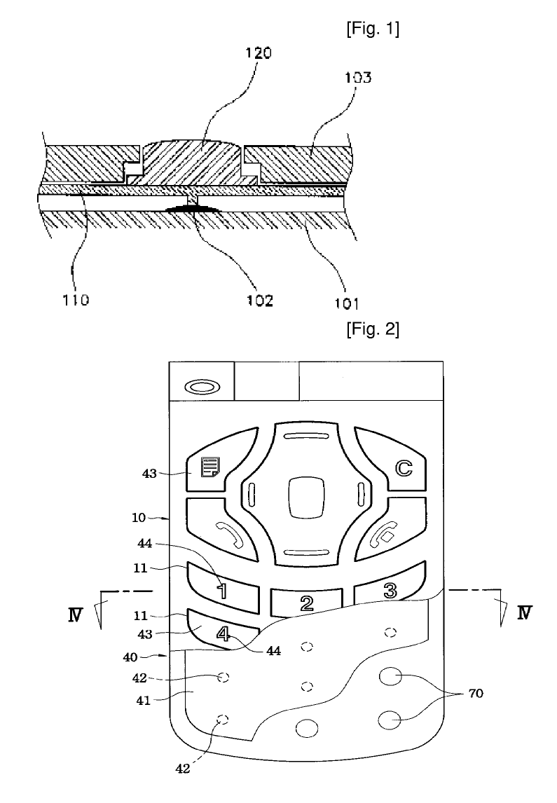

### BEST MODE FOR CARRYING OUT THE INVENTION

Reference will now be made in detail to preferred embodiments of the present invention, examples of which are illustrated in the accompanying drawings.

### Embodiment 1

Referring to FIGS. 2 through 4, a mobile phone includes a housing 10 for holding a printed circuit board 60 having a plurality of stationary contacts 61, and a dome switch 70 having a plurality of movable contacts 71 and disposed on the printed circuit board 60, and a keypad assembly 40 for operating the movable contacts 71 of the dome switch 70. The keypad assembly 40 includes a keypad 41 disposed on the dome switch 70 and having a plurality of bosses 42 protruded from a position corresponding to the movable contacts 71, and a plurality of metal keys 43 each disposed on the keypad 41 at a position corresponding to each boss 42 and protruding from a surface of the housing 10 at a desired height, each of the metal keys formed with a numeral and/or character display 44 penetrating through an upper surface thereof.

Specifically, the mobile phone of the present invention includes a lower housing 10 for holding the keypad assembly 40, an upper housing 20 disposed on the lower housing 10 and having a liquid crystal display 21 at a rear side thereof, a hinge unit 30 for hingedly coupling the upper housing to the lower housing 10, and a battery 50 detachably mounted to a lower portion of the lower housing 10.

The lower housing 10 forms appearance of the mobile phone, and encloses the printed circuit board 60 having a plurality of stationary contacts 61, and the dome switch 70 having a plurality of movable contacts 71 and disposed on the printed circuit board 60.

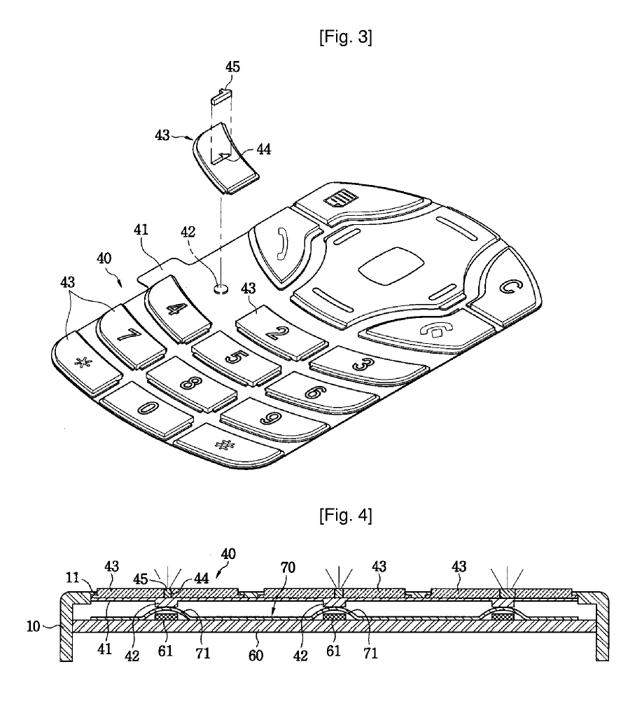

The keypad assembly 40 is disposed on the lower housing 10, i.e., the dome switch 70, to operate the movable contacts 71 of the dome switch 70, the description of which will be described with reference to FIGS. 3 and 4.

The keypad assembly 40 includes the keypad 41 disposed on the dome switch 70, and a plurality of metal keys 43 each disposed on the keypad 41 and protruding from the surface of the lower housing 10 at a desired height, each of the metal keys formed with a numeral and/or character display 44 on the upper surface thereof.

The keypad 41 consists of a membrane pad made of silicon or synthetic resin, and covers the dome switch 70 sufficiently. The keypad assembly 40 includes a plurality of bosses 42 protruded from a position corresponding to the movable contacts 71 at a bottom of the keypad. The movable contacts 71 of the dome switch 70 are easily operated by the bosses 42 of the keypad 41.

The metal keys 43 are attached to the upper portion of the key pad 41 corresponding to the bosses 42 with an adhesive, respectively, and protrude the surface of the lower housing 10 at a desired height. To this end, the surface of the lower housing 10 is formed with a through-hole 11 at a position corresponding to each metal key 43.

The metal keys 43 are made of a metal plate, in which the numerals and/or characters easily are provided thereto. Specifically, the metal keys 43 are provided with the numerals and/or character display 44 penetrating through the upper portion of the metal key by laser beam machining, pressing or etching.

A synthetic resin 45 having a good light transmittance is inserted into the numerals and/or character display 44 formed on the metal key 43. The synthetic resin may be any one selected from a group consisting of epoxy, urethane, transparent acryl, and a compound thereof.

If the numerals and/or character display 44 is provided with the synthetic resin 45 through molding, it is possible to prevent alien substance from being held between the numerals and/or character display 44, and to transmit light emitted from the lower housing 10 (called as backlighting) through the metal key 43.

Although the numerals and/or character display 44 is filled with the epoxy resin having a good light transmittance in this embodiment, the numerals and/or character display 44 may be made of the synthetic resin such as urethane, silicon and transparent acryl.

Also, although the embodiment is described that the metal keys 43 are formed of the metal plate, it may be made of stainless steel, aluminum alloy, titanium alloy, copper alloy, or the like.

Since the metal key 43 is made of metal (steel), it can represent a metal feeling and a mirror effect, in addition to various colors through deposition, coloring or plating.

Also, the metal keys 43 may have various pattern such as hair line, and various shapes. The metal keys 43 have discoloring property and good durability, since initial color and design of metal are maintained for a long time.

If the metal key is made of metal, a thickness of the metal key can be reduced to ⅓or less as compared with a key made by insert or injection method. As a result, the keypad assembly 40 can be slimmed. Also, since the metal key 43 is made by the laser beam or etching, a specific tool is not required. As such, the metal key can be mass produced, and adaptation for design change is excellent.

Operation of the embodiment will now be described.

Referring to FIG. 4, when the upper housing 20 is opened, backlight lightning in the lower housing 10 is driven to emit light. The light transmits through the numerals and/or character display 44 of the metal key 43 and the key pad 41.

In the state the upper housing 20 is opened, when a user pushes down the numerals and/or character display 44 of the metal key 43 with his/her finger, the movable contact 71 of the dome switch 70 is resiliently deformed by the boss 42 of the keypad 41 and is depressed down. As such, the movable contact 71 of the dome switch 70 is electrically connected with the stationary contact 61 of the printed circuit board 60, thereby inputting a signal to operate the mobile phone.

After inputting the signal, when the user detaches his/her finger from the metal key 43, the movable contact 71 is restored to its original position by the resilient force of the dome switch 70, and simultaneously, the metal key 43 also moves up.

As described above, the metal keys 43 operated by the finger are made of metal, and the numerals and/or character displays 44 are installed into the metal keys 43, the metal keys are not deformed during repeated use.

Also, since the numerals and/or character display 44 is provided with the synthetic resin 45 having the light transmittance through molding, it is possible to prevent alien substance from being held between the numerals and/or character display 44, and transmit the light emitted from the lower housing 10 through the metal key 43.

### Embodiment 2

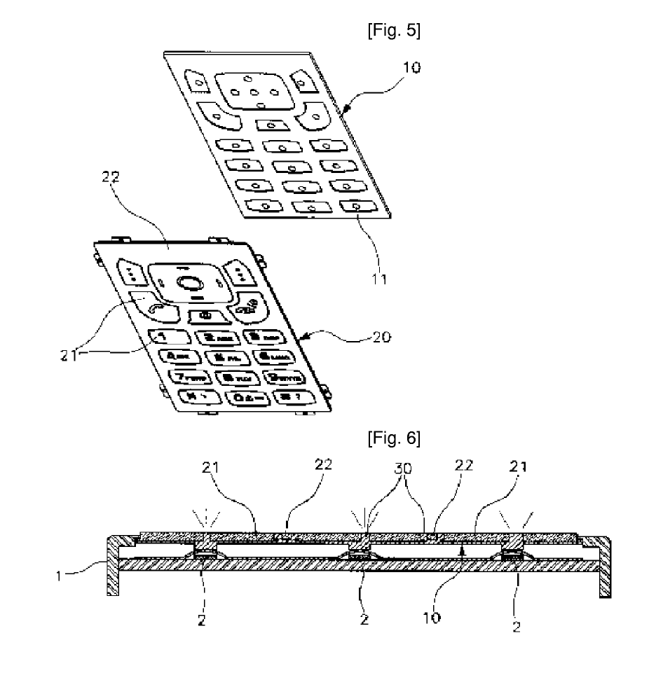

Referring to FIGS. 5 through 10, a keypad assembly disposed on a circuit board of a mobile phone for operating movable contacts for a button portion 1, comprising: a contact base 10 made of synthetic resin covering the movable contacts 2 and having a plurality of contact bosses 11 protruding downward from the contact base at a position corresponding to the movable contacts 2 to operate the button portion 1; a metal key 20 having a keypad 21 covering an upper surface of the contact base 10 and formed with punched portions for numerals and/or characters corresponding to the contact bosses 11, and a housing 22 enclosing the keypad 21; and a molding portion 30 filled in the punched portions of the metal key 20 coupled to the contact base 10.

As shown in FIGS. 5 and 6, the contact base 10 covers the movable contacts 2, and has a plurality of contact bosses 11 protruding downward from the contact base at a position corresponding to the movable contacts 2 to operate the button portion 1. The metal key 20 is made of any one selected from a group consisting of stainless steel, aluminum alloy, titanium alloy, copper alloy, or the like to cover the upper surface of the contact base 10. The metal key 20 has the keypad 21 formed with the punched portions for numerals and/or characters corresponding to the contact bosses 11, and the housing 22 enclosing and fixing the keypad 21.

The molding portion 30 made of synthetic resin is filled in the punched portions of the metal key 20 coupled to the contact base 10.

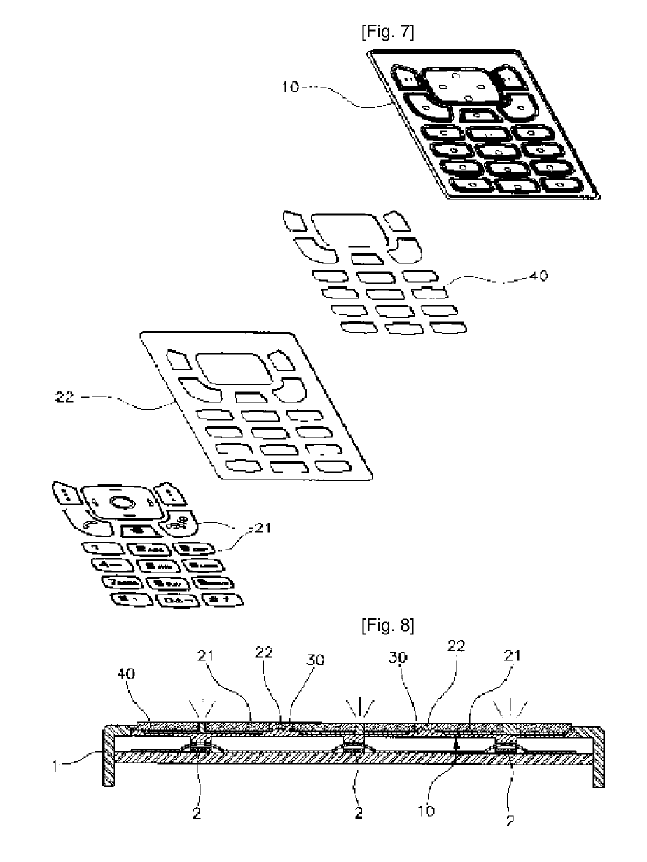

As shown in FIGS. 7 and 8, the housing 20 of the metal key 20 may be separately manufactured to connect and disconnect from the keypad 21, and a reinforcing portion 40 having a desired thickness is interposed between the contact base 10 and the metal key 20.

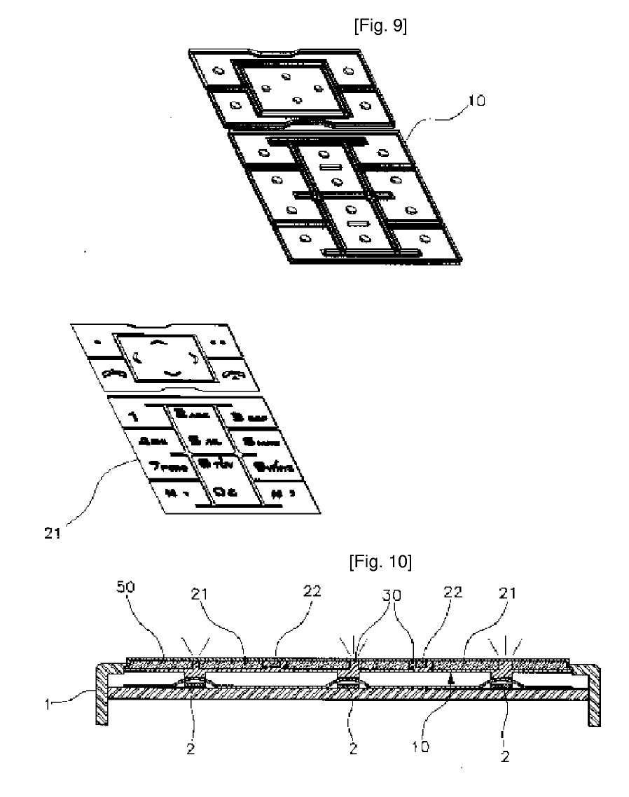

As shown in FIG. 9, the metal key 20 may have two keypads 21 to reinforce rigidity of the keypad. As shown in FIG. 10, an upper surface of the metal key 20 may be coated with a surface protecting film 50 for polishing the metal key 20.

Operation of the embodiment will now be described.

As shown in FIGS. 5 and 6, the button portion 1 of the keypad assembly is operated by the bosses of the rectangular contact base 10 corresponding to the movable contacts 2 of the mobile phone. The metal key 20 covering the upper surface of the contact base 10 is formed with the punched portions for numerals and/or characters, and the molding portion 30 is filled in the punched portions of the metal key 20.

Specifically, the contact base 10 is formed to cover the movable contacts 2, and has a plurality of contact bosses 11 protruding downward from the contact base at a position corresponding to the movable contacts 2 to operate the button portion 1.

Since the metal key is made of any one selected from a group consisting of stainless steel, aluminum alloy, titanium alloy, or the like, it can represent a metal feeling, in addition to various colors. Also, since the metal key is slimmed, it can minimize a thickness of the mobile phone.

Also, the keypad 21 of the metal key 20 is formed with the punched portions for numerals and/or characters corresponding to the contact bosses 11. At that time, since the punched portions of the keypad 21 are formed by etching, it can remarkably reduce a manufacturing cost as compared with a conventional keypad assembly using a mold.

In addition, the housing 20 fixing the keypad 21 is integrally formed with the keypad 21 to assemble the metal key 20 and the button portion 1 at once, thereby significantly reducing a manufacturing cost. The molding portions 30 are filled in the punched portions of the metal key 20 to transmit the light through the molding portion.

As shown in FIG. 7, since the housing 22 of the metal key 20 is formed to connect and disconnect from the keypad 21, the housing 22 can be used with a conventional keypad. It is possible to reinforce rigidity of the metal key 20 by the reinforced portion 40 interposed between the contact base 10 and the metal key 20, although the metal key 20 is slimed.

As shown in FIG. 8, since the metal key 20 is formed by two keypads 21, the rigidity of the keypad 21 is increased. The metal key 20 may be formed with only keypad 21 to achieve another esthetic feeling.

As shown in FIG. 9, the upper surface of the metal key 20 may be coated with the surface protecting film 50 to form the metal key in various shapes and thus advance the image of the mobile phone.

### Embodiment 3

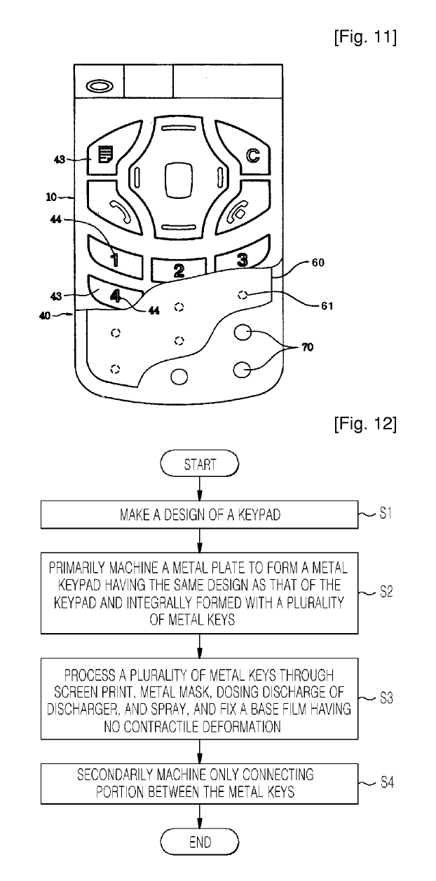

Referring to FIGS. 11 through 17, a method of manufacturing a keypad assembly for a mobile phone including a housing for holding a printed circuit board having a plurality of stationary contacts, and a dome switch having a plurality of movable contacts and disposed on the printed circuit board, the method comprising the steps of: making a design of a keypad; primarily machining a metal plate to form a metal keypad having the same design as that of the keypad and integrally formed with a plurality of metal keys; processing a plurality of metal keys through screen print, metal mask, dosing discharge of discharger, and spray, and fixing a base film having no contractile deformation; and secondarily machining only connecting portion between the metal keys.

As shown in FIG. 11, the keypad assembly includes a keypad base 60 covering a dome switch 70, and a plurality of metal keys 43 attached to an upper portion of the keypad base 60 and protruding from a surface of the housing 10 at a desired height, each of the metal keys formed with a numeral and/or character display 44.

The keypad is formed by laser beam machining, pressing, etching or NC, and is made of stainless steel, aluminum alloy, titanium alloy, copper alloy, or the like.

Preferably, the metal keys are made of a synthetic resin having light transmittance, such as epoxy, urethane, vitro, silicon or UV ink, through any one of screen print, metal mask, dosing discharge of discharger, and spray.

The process of manufacturing the keypad will now be described with reference to FIGS. 12 through 17.

The mobile phone of the present invention includes a lower housing 10 for holding the keypad assembly 40, an upper housing 20 disposed on the lower housing 10 and having a liquid crystal display 21 at a rear side thereof, a hinge unit 30 for hingedly coupling the upper housing to the lower housing 10, and a battery 50 detachably mounted to a lower portion of the lower housing 10. The lower housing 10 forms appearance of the mobile phone, and encloses the printed circuit board 60 having a plurality of stationary contacts 61, and the dome switch 70 having a plurality of movable contacts 71 and disposed on the printed circuit board 60.

First, it makes the design of the keypad, as shown in FIG. 12 (step S1).

Then, a metal plate 100 is primarily machined to form a metal keypad having the same design as that of the keypad and integrally formed with a plurality of metal keys 43 (steps S2). At this time, the metal keys are made through laser beam machining, pressing, etching or NC,

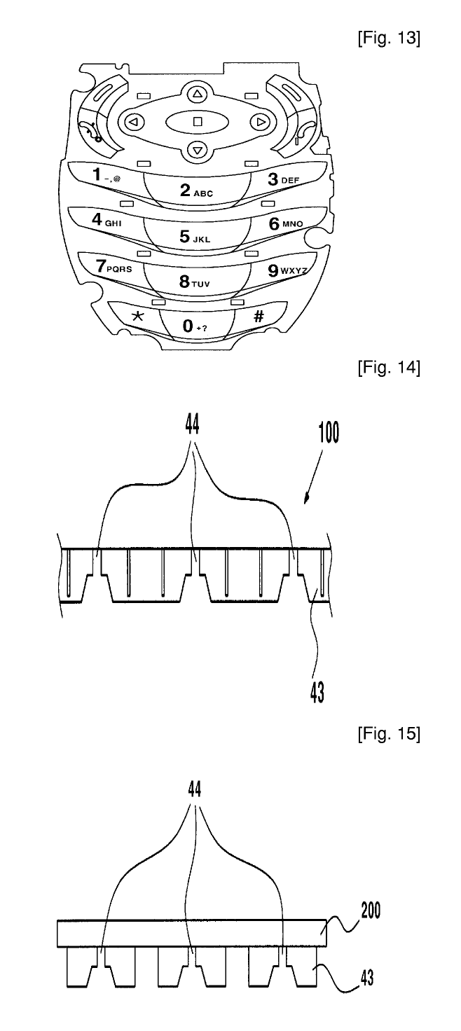

In step S2, the metal keys 43 are formed with a numeral and/or character display 44 penetrating through an upper portion of the metal key to provide the numeral and/or character display with a lighting effect, as shown in FIG. 13.

At this time, the numeral and/or character display 44 of each metal key provided through the primary process has a stepped portion at a lower portion thereof, so that when the metal key is filled with a transparent resin it prevents the resin from being released from the upper surface. Also, the synthetic resin is easily filled by an inclined portion.

Then, as shown in FIG. 14, a plurality of metal keys are formed through screen print, metal mask, dosing discharge of discharger, and spray, and a base film 200 having no contractile deformation is fixed to a plurality of metal keys 43 (step S3).

At this time, as shown in FIG. 15, the numeral and/or character penetrating the metal key is filled with a synthetic resin having light transmittance through screen print, metal mask, dosing discharge of discharger, and spray.

Alternatively, a plurality of metal keys with a punched portion are filled with the resin through silicon forming or injection molding, and simultaneously, the metal keys are assembled to the keypad base 60 in batch, in step S3.

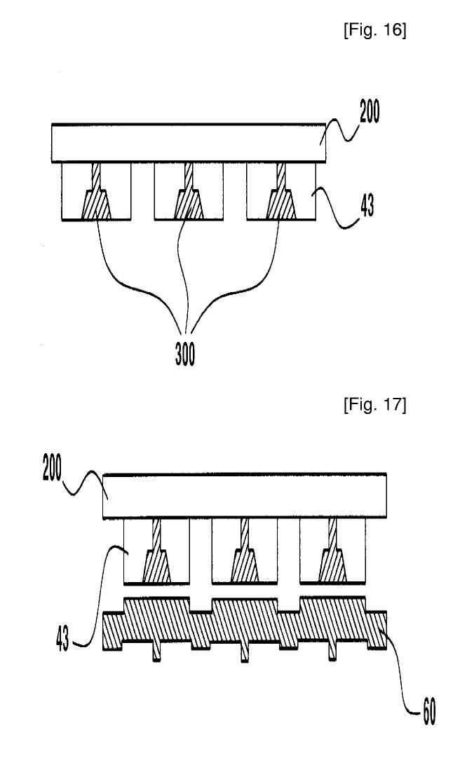

Only connecting portion between the metal keys 43 is removed through secondary machining (step S4). Then, the base film 200 having no contractile deformation is fixed to a plurality of metal keys 43, as shown in FIG. 16.

The process is completed by fixing a plurality of metal keys 43 and the keypad base 60 to the base film 200 having no contractile deformation, as shown in FIG. 17.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention relates to a keypad assembly to operate a dome switch of a mobile phone, and particularly to a structure of the keypad assembly and a method of manufacturing the same.

1. A keypad assembly for a mobile phone including a housing 10 for holding a printed circuit board 60 having a plurality of stationary contacts 61, and a dome switch 70 having a plurality of movable contacts 71 and disposed on the printed circuit board 60, the keypad assembly comprising:
a keypad 41 disposed on the dome switch 70 and having a plurality ob bosses 42 protruded from a position corresponding to the movable contacts 71;
a plurality of metal keys 43 each disposed on the keypad 41 at a position corresponding to each boss 42 an protruding from a surface of the housing 10 at a desired height, each of the metal keys formed with a numeral and./or character display 44 penetrating through an upper surface thereof; and
a synthetic resin 45 filled in the numeral and/or character display 44 of the metal key 43 to transmit light through the numeral and/or character display.

2. The keypad assembly as claimed in claim 1, wherein the synthetic resin 45 is any one selected from a group consisting of epoxy, urethane, and transparent acryl.

3. The keypad assembly as claimed in claim 1, wherein the metal key 20 is made of any one selected from a group consisting of stainless steel, aluminum alloy, titanium alloy, and copper alloy.

4. A keypad assembly for a mobile phone comprising:
a contact base 10 made of synthetic resin covering movable contracts 2 and having a plurality of contact bosses 11 protruding downward from the contact base at a position corresponding to the movable contacts 2 to operate button portion 1;
a metal key 20 having a keypad 21 covering an upper surface of the contact base 10 and formed with punched portions for numeral s and/or characters corresponding to the contact bosses 11, and a housing 22 enclosing the keypad 21; and
a molding portion 30 each filled in the punched portions of the metal key 20 coupled to an upper portion of the contact base 10.

5. The keypad assembly as claimed in claim 4, wherein the metal key 20 is made of any one selected from a group consisting of stainless steel, aluminum alloy, titanium alloy, and copper alloy.

6. The keypad assembly as claimed in claim 4, wherein a reinforcing portion 40 is interposed between the contact base 10 and the metal key 20 to increase a thickness and strength thereof.

7. The keypad assembly as claimed in claim 4, wherein the metal key 20 has a surface protecting film 50 on an upper portion thereof.

8. The keypad assembly as claimed in claim 4, wherein the metal key 20 has a surface protecting film 50 on an upper portion thereof.

9. A method of manufacturing a keypad assembly for a mobile phone including a housing for holding a printed circuit board having a plurality of stationary contacts, and a dome switch having a plurality of movable contacts and disposed on the printed circuit board, the method comprising the steps of:
primarily machining a metal plat to form a metal keypad having the same design as that of the keypad and integrally formed with a plurality of metal keys;
processing a plurality of metal keys through screen print, metal mask, dosing discharge of discharger, and spray, and fixing a base film having no contractile deformation; and
secondarily machining only connecting portion between the metal keys.

10. A method of manufacturing a keypad assembly as claimed in claim 9, wherein the primarily machining step further includes a step of machining a numeral and/or character display 44 to penetrate an upper portion of the metal key.

11. [canceled]

12. A method of manufacturing a keypad assembly as claimed in claim 9, wherein the primarily and secondarily machining step are performed by any one of laser beam machining, pressing, etching, and NC.

13. A method of manufacturing a keypad assembly as claimed in claim 9, wherein after the secondarily machining step, the metal keys are assembled to the keypad base in batch, without using a separate aligning process.

14. A method of manufacturing a keypad assembly for a mobile phone including a housing for holding a printed circuit board having a plurality of stationary contacts, and a dome switch having a plurality of movable contacts and disposed on the printed circuit board, the method comprising the steps of:
making a design of a keypad;
primarily machining a metal plate to form a metal keypad having the same design as that of the keypad and integrally formed with a plurality of metal keys;
integrally forming a keypad base and contact bosses on a metal base; and
secondarily machining only connecting portion between the metal keys.

15. A method of manufacturing a keypad assembly for mobile phone including a housing for holding a printed circuit board having a plurality of stationary contacts, and a dome switch having a plurality of movable contacts and disposed on the printed circuit board, the method comprising the steps of:
making a design of a keypad;
primarily machining a metal plate to form a metal keypad having the same design as that of the keypad and integrally formed with a plurality of metal keys;
filling a lower portion of a metal base with a numeral and/or character, and simultaneously forming contact bosses on the metal base;
attaching a film to the metal base; and
secondarily machining only connecting portion between the metal keys.

16. The method of manufacturing a keypad assembly as claimed in claim 9, wherein the numeral and/or character display 44 are made of a synthetic resin having light transmittance, such as epoxy, urethane, vitro, silicon or UV ink, through any one of screen print, metal mask, dosing discharge of discharger, and spray.

17. The method of manufacturing a keypad assembly as claimed in claim 10, wherein the numeral and/or character display 44 are made of a synthetic resin having light transmittance, such as epoxy, urethane, vitro, silicon or UV ink, through any one of screen print, metal mask, dosing discharge of discharger, and spray.
